(19) United States
(12) Patent Application Publication
(10) Pub. No.: US 2009/0197234 A1
(43) Pub. Date: Aug. 6, 2009

(54) SYSTEM AND METHOD FOR A VIRTUAL SCHOOL

(76) Inventors: Damian Creamer, Chandler, AZ (US); Manoj Modi, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/359,930

(22) Filed: Jan. 26, 2009

Related U.S. Application Data
(60) Provisional application No. 61/025,068, filed on Jan. 31, 2008.

(51) Int. Cl. G09B 3/00

(52) U.S. Cl. 434/350

(57) ABSTRACT

The present invention is directed at a software system for use in an online educational environment. In one embodiment, a software system combines and allows communication between a student management system, a learning management system, and various other portals are interconnected and communicate with one another to allow for an completely integrated online educational institution that allows patents, students, and educators to plan and monitor a student's progress.

### CROSS REFERENCE TO RELATED APPLICATIONS

This application claims benefit and priority of U.S. Provisional Patent Application Ser. No. 61/025,068 entitled “Management System For Online Education Providers” filed on Jan. 31, 2008.

### FIELD OF INVENTION

The present invention relates to an improved software system for managing students enrolled in an online educational program. More specifically, the present invention is directed at an improved software system for an education provider to enable an efficient, seamlessly integrated Virtual School.

### BACKGROUND OF THE INVENTION

Online education continues to be a growing industry that fosters innovation and competition among service providers. In this competitive world of online education, implementing a quality e-learning program typically presents a number of unique challenges and risks; both logistically and financially. Any education or training service provider (e.g. a school, university or industry association) must analyze and balance curriculum standards and compliancy requirements, information technology resources and the administrative and human resources necessary to effectively develop, deploy, operate and maintain a viable online educational offering. Furthermore, in this increasingly busy world, students need to access information to better manage the demands on their time. For instance, with more students living in non-traditional family settings (e.g., single-parent, armed service, work abroad, farming, and other scenarios), accessing a fully-online curriculum provides students the flexibility to access their classes anytime; from anywhere they have access to the Internet without sacrificing the quality of their education.

To address the demand for online education services, companies have developed solutions aimed at providing the software and services necessary to support the various aspects of online education. Many companies have focused on the set of tools necessary to develop and deliver content to the student. These solutions are called learning management systems (“LMS”). A typical LMS includes a set of interfaces that enable interaction with the student. Through web-based user interfaces (UIs), students are able to register, pay, access content (e.g. class lectures and materials) and review their performance. Another set of UIs often allow parents or other authorized individuals a view of a student's progress and performance. A second function of a typical LMS enables content providers to develop, upload, update and manage course materials supporting text, graphic and video formats. Furthermore, with the increase in popularity of online social networks, some LMS vendors have also started to add collaboration and community building tools into their LMS products.

Developing and delivering educational course content is only a small part component of an educational institution's needs. Current online educational systems typically employ numerous software systems, manual processes, and data sources to operate. For example, one of the principal software components that is lacking is a software system that allows an online educational provider to monitor and manage its students. It would be advantageous to provide a software system that managed students that allowed staff members to view the activity of other staff members and coordinate and or manage one another. Therefore, a long felt need exists for a virtual school system that enables comprehensive automation, integration and functionality for an educational provider.

### SUMMARY OF THE INVENTION

The present invention provides systems and methods to define, automate and implement processes and tools for a virtual school. In one embodiment, the system comprises numerous interconnected applications and software subsystems that are configured for the total management of an online educational institution.

In one embodiment, a virtual school system provides dynamic, customizable user interfaces, data processing functions, process definition, rule definition and rule evaluation capabilities, workflow functionality, interoperability with existing educational and government systems and processes, and planning, reporting, audit and compliance functions. The virtual school system (“VSS”) comprises a student management system (“SMS”) for managing a plurality of students, a learning management system (“LMS”) for managing and delivering the content of a plurality of online courses and a school administration system (“SAS”) for managing the administrative functions of at least one virtual school. The VSS further includes a workflow engine to define processes, evaluate predefined rules and automate workflow, and a central data repository to store, manage, track and integrate comprehensive data for an educational environment. The VSS provides relevant content and rich functionality to users through dynamic and customizable user interfaces.

In one embodiment, a system and/or method allows students to completely enroll online. According to this embodiment, the SMS is configured to allow faculty and staff at an online educational institution to properly admit students, provide them necessary guidance counseling and various other instructions. A parent/student portal (“PSP”) provides parents and students access to an LMS and numerous other portals and databases such as client database and a standardized testing database. Therefore, the system of the present invention manages a student's entire educational process from admission through graduation or course completion.

In one embodiment, the system comprises a software based student management system in communication with a learning management system. The student management system of the present invention is configured to enable an online educational system provider to manage its student body. Further, according to another embodiment, the student management system is configured to enable staff members to contact and follow up with one another to ensure that all students' needs are adequately met. According to one embodiment, the software system further comprises a parent/student portal. According to another embodiment, the system of the present invention further comprises an application portal that enables student to apply for admission into an online educational program.

### BRIEF DESCRIPTION OF THE DRAWINGS

The subject invention will hereinafter be described in conjunction with the appended drawing figures, wherein like numerals denote like elements, and wherein;

FIG. 1 is a block diagram depicting various system components for a virtual school system, in accordance with one embodiment of the present invention;

FIG. 2 is a flow chart depicting representative process for configuring a virtual school, in accordance with one embodiment of the present invention;

FIG. 3 is a flow chart depicting a representative application process, in accordance with one embodiment of the present invention;

FIG. 4 is a flow chart depicting a representative process for assigning classes to a student, in accordance with one embodiment of the present invention; and

FIG. 5 is a flow chart depicting a representative process for coordinating a standardized test, in accordance with one embodiment of the present invention.

### DETAILED DESCRIPTION

The detailed description of exemplary embodiments of the invention herein makes reference to the accompanying drawings, which show embodiments by way of illustration and best mode. While these embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a user interface (UI), a software module, logic engines, numerous databases and computer networks. While the system may contemplate upgrades or reconfigurations of existing processing systems, changes to existing databases and business information system tools are not necessarily required by the present invention.

The benefits provided by this invention include, for example, increased quality of service, increased functionality, increased efficiency, cost savings and increased integration with government, regulatory and educational systems. For the student, the system provides a more seamless, easy-to-use, intuitive educational environment. This environment helps students to achieve their educational goals easier and faster. The integrated environment prevents duplicate entry of information and the need to access multiple systems to complete education requirements. For example, the system allows a student, from a single interface, to apply for admissions, plan their course of study, register for courses, receive guidance, make payments, receive course instruction, view course content, participate in online discussions, complete assessments (e.g., exams, quizzes, etc.), review current and past performance, coordinate meetings with instructors, parents and administrators, and sign up for standardized tests. Thus, the student benefits from time saving features, richer education delivery mechanisms, such as a discussion interface, and integrated functions to provide support services such as guidance counseling and parental participation functions.

The education provider benefits from fewer manual processes, increased integration of automated systems, the ability to efficiently manage students, staff and resources and efficient reporting, compliance and audit capabilities. The system enables the education provider automate a comprehensive set of school functions, from planning to instruction to compliance with government rules and standards. The integrated student management interface allows administrators to assign and track resources, guidance staff to manage student interactions and instructors to plan and manage classes. The central data repository integrates the data into a universal data model that allows for more accurate information and that reduces duplicate entry. The workflow and rules engine capabilities allow the education provider to set up and automate a school's processes and automatically track and assign tasks to various staff members.

Briefly, while the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as personal digital assistants.

“Entity” may include any individual, consumer, customer, group, business, organization, government entity, software, hardware, and/or any other entity.

“Online educational system provider” or “education provider” or “school” includes any entity that provides educational courses, whether those courses are part of an accredited education curriculum or not, such as online primary or high schools, colleges or universities, institutions providing courses for a particular profession (such as continuing legal education courses for attorneys) or any individual or entity providing courses that are capable of being taught online either now or in the future.

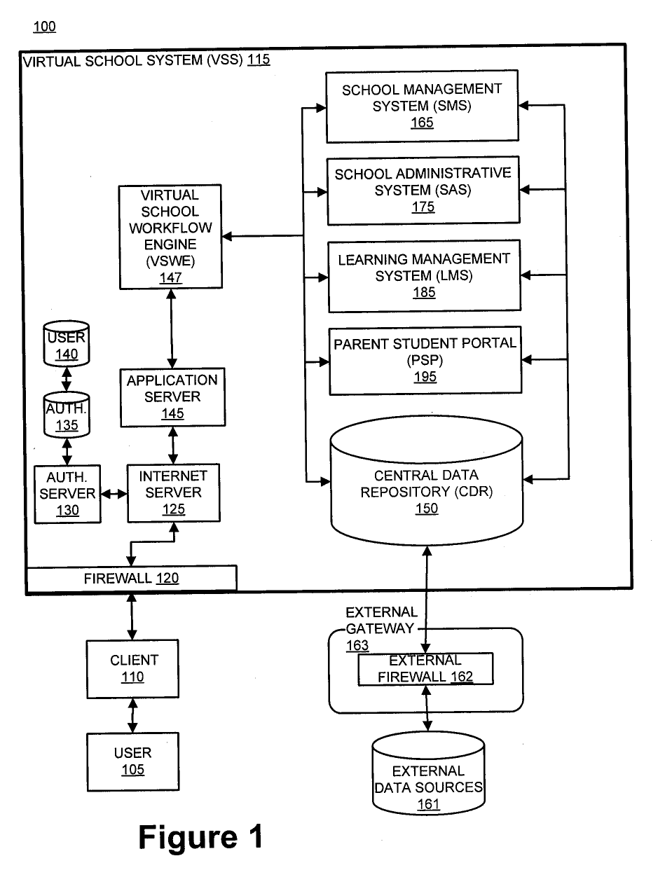

A “user” may include any individual or entity that interacts with a system or participates in a process. With reference to FIG. 1, user 105 may perform tasks such as requesting, retrieving, receiving, updating, analyzing, entering and/or modifying data. User 105 may interface with Internet server 125 via any communication protocol, device or method discussed herein, known in the art, or later developed. User 105 may be, for example, be a student, a parent (or any user responsible for a student), instructor, an administrator, a government official, etc. In one embodiment, users are assigned to roles that are used to determine user permissions or default user interfaces. For instance a user 105 may be assigned to an administrator role and the user interfaces may be tailored to present data and provide functions relevant to an administrator.

In one embodiment, with reference to FIG. 1, system 100 includes a user 105 interfacing with a VSS 115 by way of a client 110. Client 110 comprises any hardware and/or software suitably configured to facilitate requesting, retrieving, updating, analyzing, entering and/or modifying data. The data may include verification data, authentication data, instructional data, demographic data, testing data, transaction data, performance and reporting data or any information discussed herein. Client 110 includes any device (e.g., personal computer), which communicates (in any manner discussed herein) with the VSS 115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 110 may or may not be in direct contact with the VSS 115. For example, the client 110 may access the services of the VSS 115 through another server, which may have a direct or indirect connection to Internet server 125.

User 105 may communicate with the VSS 115 through a firewall 120 to help ensure the integrity of the VSS 115 components. Internet server 125 may include any hardware and/or software suitably configured to facilitate communications between the client 110 and one or more VSS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140. Application server 145 may include any hardware and/or software suitably configured to serve applications and data to a connected client 110.

According to one embodiment of the present invention, VSS 115 is used to manage and completely integrate an online or other computer-based educational environment. VSS 115 is a fully integrated system comprised of various subsystems, modules and databases. With reference again to FIG. 1, VSS 115 combines and allows communication between SMS 165, SAS 175, LMS 185, PSP 195, various other portals and UIs (not shown in FIG. 1), central data repository (“CDR”) 150 and external data sources 161. In one embodiment, UIs are accessed via a web portal and the elements of the UI may be comprised of movable, resizable web parts. These components are interconnected and communicate with one another to allow for a completely integrated online educational institution that allows parents, students, instructors, administrators, regulators, auditors, government officials and other educators to plan and monitor all the activities and operations of a educational institution.

Virtual school workflow engine (“VSWE”) 147 is a software module configured to enable online functions such as receiving query requests, configuring responses, dynamically configuring user interfaces, requesting data, receiving data, prompting user 105 with security challenges, verifying user responses, authenticating the user, initiating VSS 115 processes, initiating other software modules, encrypting and decrypting. Additionally, VSWE 147 may include any hardware and/or software suitably configured to receive requests from client 110 via Internet server 125 and the application server 145. VSWE 147 is further configured to process requests, execute transactions, construct database queries, and/or execute queries against databases, within system 100 (e.g., central data repository (“CDR”) 150), external data sources 161 and temporary databases.

VSWE 147 is configured to exchange data with other systems and application modules such as SMS 165, SAS 175, LMS 185, and PSP 195. In one embodiment, the VSWE 147 may be configured to interact with other system 100 components to perform complex calculations, retrieve additional data, format data into reports, create XML representations of data, construct markup language documents, construct, define or control UIs, and/or the like. Moreover, VSWE 147 may reside as a standalone system or may be incorporated with the application server 145 or any other VSS 115 component as program code. As one of ordinary skill in the art will appreciate, VSWE 147 may be logically or physically divided into various subcomponents such as a workflow engine configured to evaluate predefined rules and to automate processes associated with a virtual school implemented in VSS 115. In one embodiment, VSWE 147 is configured to automate, track, route, status and manage tasks, messages and events associated with other VSS subsystems and integrated virtual school processes.

SMS 165 is a software subsystem and integrated component of VSS 115 that allows staff to manage and track students enrolled in classes, or otherwise accessing educational content or instruction, provided by the online educational system provider. SMS 165 is comprised of multiple software applications and/or computer modules which are configured to automate a plurality of student management functions including admissions, student registration, course registration, course planning, student counseling, course scheduling, performance tracking, attendance tracking, and assessment reporting. Enrolled students (as well as potential students) and their progress are managed by SMS 165.

SMS 165 further comprises various UIs for staff members to access. Any number of staff members can access SMS 165 and a staff member can have greater access to student records than other staff members depending on the particular staff member's need. Staff members that access SMS 165 include admissions staff, guidance counselors, administrators, teachers, professors, and other instructors.

SAS 175 is a software subsystem and integrated component of VSS 115 that enables user 105 (e.g., a school administrator) to manage the administrative functions of a school. In one embodiment, SAS 175 includes a budgeting module, a finance module, a resource management module, an operational performance tracking and reporting module, a regulatory module and a compliance reporting module.

LMS 185 is a software subsystem and integrated component of VSS 115. In one embodiment, LMS 185 is configured to automate a plurality of learning management functions including course development, course management, course delivery, assessment creation, assessment delivery, and assessment evaluation. In one embodiment, course management includes enforcing course content requirements that may be mandated by, for example, an accreditation authority, a school board, a school district, a state government, the federal government, or an education industry standard.

In one embodiment, LMS 185 is “commercial off the shelf” software purchased from a vendor and configured to integrate with VSS 115 components, functions and data. However, any other type of similar virtual learning program is within the scope of the present invention, including ones that are completely custom. Furthermore, the term “learning management system” or LMS is not meant to be limited to any specific software program. Rather, the terms “learning management system” or “LMS” denote any software program that provides educational material to students. Certain exemplary LMS 185, comprise, but are not limited to a Course Management System (CMS), a Learning Content Management Systems (LCMS), a Managed Learning Environment (MLE), a Learning Support System (LSS), or a Learning Platform (LP) software systems. In one embodiment, LMS 185 is connected to and in communication with PSP 195 and allows students to access all the educational material in LMS 185 via PSP 195. In one embodiment, CDR 150 stores data to populate the content of UIs and parameter data useful in dynamically configuring and/or customizing the UIs.

PSP 195 comprises software modules and UIs configured to provide user 105 (e.g., a parent or a student) access to the information and functionality of VSS 115. In one embodiment, PSP 195 includes a virtual class room, an online discussion UI, a messaging UI, an admissions UI, a course information UI, a guidance UI, a social networking UI, and a student portfolio UI. The data and form of the interfaces may be standardized or customized. In one embodiment, PSP 195 is a web portal and the data provided in the web portal is presented in customizable web parts. In one embodiment, the guidance UI comprises graduation progress data, transcript data, an academic status indicator, course scheduling data, standardized testing results, academic goals and achievements, career goals and achievements, post secondary goals and achievements, and extracurricular activity participation records, goals and achievements. In an embodiment, the admissions UI includes profile data, program of study data (e.g. diploma data), an admissions checklist, enrollment data for past, current and future academic sessions, resources and forms, and student documents and records. In one embodiment, the course information UI includes course expectation data, course syllabus data, gradebook data, attendance data, progress indicators, communication or messaging data, instructor data, assignment data, and access to the virtual classroom. In one embodiment the social networking UI comprises student yearbook, newsletter, literature magazine, blogs, and peer-to-peer communication and interaction. In one embodiment the knowledge center UI includes a course catalog, FAQs, a student handbook, course expectations, tutorials, and student orientation information. In one embodiment the student portfolio UI includes accomplishments, post graduation plans, academic work samples, unofficial transcripts, course syllabi.

In addition to the components described above, system 100, VSS 115, SMS 165, SAS 175, LMS 185 and PSP 195 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 100 components may be embodied as a customization of an existing system, an add-on product, upgraded software, a stand-alone system (e.g., kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Client 110 may include an operating system (e.g., Windows XP, Windows NT, 95/98/2000, XP, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In an embodiment, access is through a network or the Internet through a commercially available web-browser software package. Client 110 and VSS 115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 110 and/or any of the system components may include wired and/or wireless portions.

Firewall 120, as used herein, may comprise any hardware and/or software suitably configured to protect VSS 115 components from users of other networks. Firewall 120 may reside in varying configurations including stateful inspection, proxy based and packet filtering, among others. Firewall 120 may be integrated as software within Internet server 125, any other system 100 component, or may reside within another computing device or may take the form of a standalone hardware component.

Internet server 125 may be configured to transmit data to client 110 within markup language documents. “Data” may include encompassing information such as commands, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, application server 145 may communicate with any number of other servers, databases and/or components through any means known in the art. Further, application server 145 may serve as a conduit between client 110 and the various systems and components of VSS 115. Internet server 125 may interface with application server 145 through any means known in the art including a LAN/WAN, for example. Application server 145 may further invoke software modules such as the VSWE 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 1 depicts databases that are included in an exemplary embodiment of the invention. An exemplary list of various databases used herein includes: an authentication database 135, a user database 140, CDR 150, external data sources 161 and/or other databases that aid in the functioning of the system. As practitioners will appreciate, while depicted as separate and/or independent entities for the purposes of illustration, databases residing within system 100 may represent multiple hardware, software, database, data structure and networking components. Furthermore, embodiments are not limited to the exemplary databases described herein, nor do embodiments necessarily utilize each of the disclosed exemplary databases.

Authentication database 135 may store information used in the authentication process such as, for example, user identifiers, passwords, access privileges, user preferences, user statistics, and the like. User database 140 maintains user information and credentials for VSS 115 users (e.g., user 105).

CDR 150 is a data repository that is configured to store a wide variety of comprehensive data for a virtual school. While depicted as a single logical entity in FIG. 1, those of skill in the art will appreciate that CDR 150 may, in some embodiments, consist of multiple physical and/or logical data sources. In one embodiment, CDR 150 stores demographic data, historical data, academic records, reporting data, audit records, predefined rules (e.g., a government requirement), process definitions (e.g., the admissions process), educational content, financial data, schedules, resource management data and the like.

External data source 161 represents databases and other data sources that are accessible by CDR 150 and other VSS 115 components. In one embodiment external data source 161 data may be provided by a school board, a school district, a state government, the federal government, the education industry, a vendor, etc. For example, in one embodiment, VSS 115 is configured to access a student's academic records from another school and integrate the data into a student information stored on CDR 150.

System 100 may be interconnected to external data source 161 (for example, to obtain data from a government entity, another school system, or a vendor) via a second network, referred to as the external gateway 163. The external gateway 163 may include any hardware and/or software suitably configured to facilitate communications and/or process transactions between system 100 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing, for example, inside CDR 150, PPS 150, the external data source 161 or any other known configuration. External gateway 163 may be configured to deliver data directly to system 100 components (such as VSWE 147) and to interact with other systems and components such as CDR 150 databases. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 is a closed network that is assumed to be secure from eavesdroppers.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

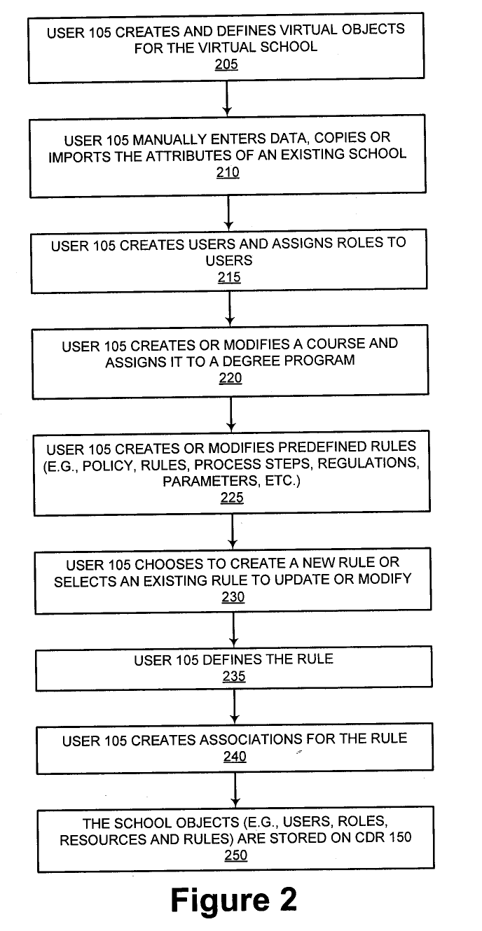

Referring now to the figures, the block system diagrams and process flow diagrams represent mere embodiments of the invention and are not intended to limit the scope of the invention as described herein. For example, the steps recited in FIGS. 2-5 may be executed in any order and are not limited to the order presented. It will be appreciated that the following description makes appropriate references not only to the steps depicted in FIGS. 2-5, but also to the various system components as described above with reference to FIG. 1.

With reference to FIG. 1, in one embodiment, when user 105 logs onto an application (e.g., PSP 195), Internet server 125 may invoke an application server 145. Application server 145 invokes logic in the VSWE 147 by passing parameters relating to the user's 105 requests for data. The VSS 115 manages requests for data from the VSWE 147 and communicates with system 100 components. Transmissions between user 105 and Internet server 125 may pass through a firewall 120 to help ensure the integrity of VSS 115 components. Practitioners will appreciate that the invention may incorporate any number of security schemes or none at all. In one embodiment, Internet server 125 receives page requests from client 110 and interacts with various other system 100 components to perform tasks related to requests from client 110.

Internet server 125 may invoke an authentication server 130 to verify the identity of user 105 and assign roles, access rights and/or permissions to user 105. In order to control access to the application server 145 or any other component of VSS 115, Internet server 125 may invoke an authentication server 130 in response to user 105 submissions of authentication credentials received at Internet server 125. When a request to access system 100 is received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

VSS 115 and CDR 150 may automate school functions and store data for multiple virtual schools. For example, VSS 115 may be configured for one virtual school or for all the schools in a school system or for a subset of schools in a state. While discussed herein in reference to a virtual school, in one embodiment, VSS 115, and its integrated components SMS 165, SAS 175, LMS 185 and PSP 195, may be implemented to automate processes, store data, manage resources, provide operational support and provide instruction for an existing “brick and mortar school.” That is, a virtual school implemented on VSS 115 may exist without the traditional physical structure (e.g., classrooms, offices, cafeteria, playground, etc.) and, in some embodiments, VSS 115 may be employed to enhance, and supplement and provide cost effective automation and educational services for an existing “brick and mortar school.”

Referring now to FIG. 2, a representative process for configuring a virtual school in VSS 115 is shown. In one embodiment, user 105 may be a school administrator who configures a new school by creating a school on VSS 115 or by modifying an existing school. User 105 may create and define virtual objects for the virtual school (Step 205). User 105 may access logic and UI's within VSWE 147 to create a virtual school on VSS 115 by manually entering data, by partially copying the attributes of an existing VSS 115 school, or by importing the attributes of an existing school from a file or from an external data source 161 (Step 210). User 105 may create other users and assign them roles (i.e., creating students, instructors, administrators, etc. as users in VSS 115) (Step 215). User 105 may create or modify a degree program, create or modify a course of instruction (“course”) and assign it to a degree program, associate content from LMS 185 with a course, assign students to a course, etc. (Step 220).

User 105 may also create or modify predefined rules (e.g., policy, rules, process steps, regulations, parameters, etc.) for the virtual school (Step 225). Predefined rules are used by VSS 115, and specifically by VSWE 147, to control, track, and make decisions within VSS 115. For instance, a predefined rule may set the length or duration of a school session (e.g., six weeks), set the minimum student age, set a maximum instructor to student ratio for classes, define Algebra and Geometry as prerequisites for a Calculus class, or specify standardized testing requirements mandated by government or regulatory authorities. User 105 chooses to crate a new rule or selects an existing rule to update or modify (Step 230). User 105 defines the rule (Step 235). In one embodiment, school rules may be copied from an existing virtual school or may be imported via an automated process from an external data source 161 such as a state's education department's web site. User 105 creates associations for the rule (Step 240). For instance, user 105 may associate the rule with another school rule, a specific program, an academic discipline, a student, a group of students, a user role, a virtual school or a virtual school system. The school objects (e.g., users, roles, resources and rules) are stored on CDR 150 (Step 245) where they can be accessed by other VSS 115 components.

As previously discussed, CDR 150 is configured to store predefined rules. As one of skill in the art will appreciate, predefined rules for a virtual school may include rules determined by an accreditation authority, a school board, a school district, a state government, the federal government, an education industry standard, online privacy best practices, the date, a student location, a student type, a class type, the subject matter of a course, a degree type, the sex of a student, the age of a student, the race of a student, or the economic classification of a student. CDR 150 enables a virtual school to operate in an automated fashion. For instance, in one embodiment, guidance counselors accessing SMS 165 functionality may generate a list of recommended courses for a student based upon state requirements, based upon an assessment of a student's completion of prerequisites (i.e., implemented as a predefined rule) and/or based upon an operational factor such as balancing the load of registered students against available resources (e.g., only fill three calculus class for the current school session).

As previously disclosed, SMS 165 enables online, integrated and centralized management of the operations of a virtual school. Predefined rules customized workflows, user roles and customized UI's enable administrators, managers, staff and instructors to manage the activities that support the educational process. For instance, in one embodiment SMS 165 includes an admissions module configured to automate the student admissions process. The admissions module for a virtual school in VSS 115 accesses CDR 150 and may access other VSS 115 components to dynamically create admissions forms (i.e., customized UI's) based upon the school admission's policies and other predefined rules. In one embodiment, an online application portal allows user 105 (e.g., a current or prospective student) to apply online for a class, a grouping of classes comprising a major or program or study, or any other educational product or service offered by an online education provider. The application portal enables students to enroll into the online educational system provider's classes by collecting the necessary data to enroll the student. The data collected at online application portal can be any information needed to enroll the student into a particular class or other program. In one embodiment, the data includes certain government required test scores, transcripts from other schools, or financial information to determine whether or not financial aid is available. The data may further comprise personal and/or demographic data about the student such as his address, telephone number, e-mail address, social security number, and a parent or guardian's contact information.

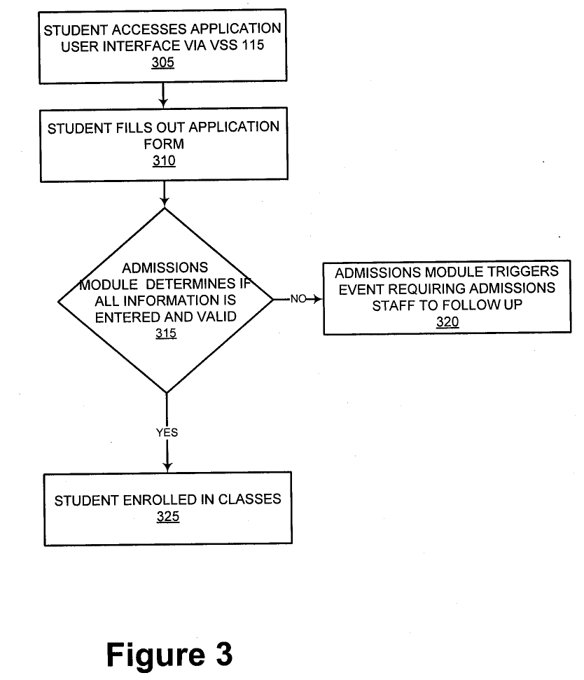

FIG. 3 shows a representative embodiment of an enrollment process enabled by SMS 165. The student accesses VSS 115 via a webpage dedicated to enrollment (Step 305). In certain embodiments, the webpage or website displays certain information needed from the student to complete enrollment. The amount and type of information requested varies depending on the online educational system provider and the type of classes or program the student enrolls in. According to this embodiment, information as to what the student can expect to happen next is also communicated to the student such as assignment of a unique login ID and password as well as class assignment. The information the student can provide is collected (Step 310). The enrollment module of SMS 165 determines if the information entered is valid and is sufficient to complete enrollment (Step 315). In one embodiment, SMS 165 accesses predefined rules stored on CDR 150 to determine if the appropriate type and quantity of information has been entered by a student by comparing the entered data with sets of data in CDR 150 to ensure that all data fields are populated with valid data (Step 320). If the student has not provided valid or sufficient information, the admissions module triggers an event or sets a data flag such that VSWE 147 will require an admissions staff member to follow up with the student (Step 325). If the data is valid and sufficient, the admissions module executes appropriate logic and saves data to CDR 150 to enroll the student (Step 330). In one embodiment, VSS 115 automatically provides the student with a unique user ID and login to provide the student access to other features of VSS 115.

In one embodiment, an admissions staff member (i.e., user 105 assigned to an admissions staff role) views admissions data on a UI. A listing of potential and enrolled students is shown and identified by a unique identification number. The UI also displays the status of each enrolled or potential student and the name of the admissions staff member or other staff that is working with that particular student. Certain students may be enrolled and need no action from admissions staff while other students are shown on the UI as being in the “screening” stage or the “document stage.” In this example, the document stage might indicate that additional documents are needed by admission staff and the particular staff member that is assigned to that potential student is also identified. Therefore, if the particular staff member assigned to obtain the documents has not done so with an appropriate time frame the workflow and scheduling functionality of SMS 165 will cause the UI to alert a different staff member. Thus, VSS 115 enables an online education provider to effectively manage staff and staff activities.

VSS 115 provides flexibility in defining processes, dynamically constructing UI's, and enforcing workflows so that differing processes can be implemented for various schools or depending on varying needs. For example, in an embodiment, the enrollment process discussed above may be substituted with an admissions and registration process whereby the student first must be admitted to a school or educational program and then enrolls in a particular session to receive instruction. The admissions module of SMS 165 admissions module may be configured to execute an admissions process that includes: receiving an application request; configuring an application form based at least partially on the content or form of the application request; receiving application data entered in the application for by a prospective student; storing the application data in CDR 150; sending an automated message to an admissions specialist, a guidance counselor or a school administrator; receiving at least one admissions response associated with the automated message; determining an admissions decision based at least partially upon the admissions response; and, informing the user of the admissions decision.

SMS 165 may also include a guidance module. Guidance staff (e.g., users 105 of VSS 115 assigned to the guidance staff role) utilize SMS 165 to perform activities associated with managing and advising students. In one embodiment, guidance staff may communicate with prospective students to obtain transcripts and schedule classes. In this regard, a guidance staff member accesses CDR 150 data (e.g., an e-mail address) and requests that the student send transcripts to the online education provider. In an embodiment, SMS 165 may be configured to allow guidance staff to communicate with other educational providers directly to obtain transcript and other needed information.

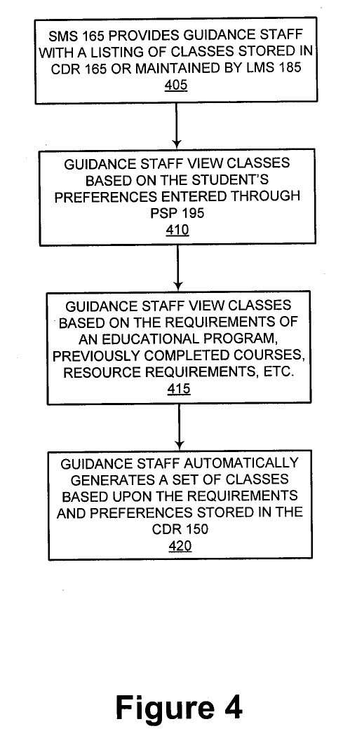

SMS 165 also enables guidance staff to schedule students for classes. With reference now to FIG. 4, in one embodiment, SMS 165 provides guidance staff with a listing of classes that are stored in CDR 165 or maintained by LMS 185 (Step 405). Guidance staff may view classes for a particular student based on the student's preferences that are communicated to guidance staff though PSP 195 (Step 410). The guidance module of SMS 165 also enables the guidance staff to view potential classes based upon other factors such as the requirements of an educational program, previously completed courses, resource requirements, etc. (Step 415). This embodiment provides an example of how SMS 165, PSP 195 and LMS 185 communicate among one another and share data through CDR 150 to provide a totally integrated software system for an online educational provider. SMS 165 may access a government data source such as a state department of education database that tracks which courses students need to graduate from school or obtain a diploma. Guidance staff may manually select classes to enroll a student in or the may automatically generate a set of classes based upon the requirements and preferences stored in the CDR 150 (Step 420). In one embodiment, a guidance staff member enrolls the student in the courses and, in an embodiment, the staff member may send the class listing to the student for approval before enrolling the student in the courses. In one embodiment, the guidance module of SMS 165 automatically generates a complete schedule of courses, including the requisite order that the courses should be taken, necessary for the student to achieve a particular goal (e.g., graduate from a high school program no later than the Spring 2010 semester).

SMS 165 enables efficiency in an educational organization by providing task lists, workflow and customized interfaces that help optimize staff operations. Configurable, data driven and dynamic user interfaces allow each user, user role or administrative function to access relevant data and functions. For instance, in one embodiment guidance staff access an interface that lists students assigned to them, provides a log (e.g., an audit trail) of guidance related interactions with the student and provides access to student data and the student admissions and/or enrollment functions discussed previously. In an embodiment, instructors view a list of courses that they are assigned to and may view a listing of students, drill down to and edit gradebook entries for a particular student, access student assignments (e.g., by downloading files submitted by the student in the LMS), send messages to a student, recommend a student for counseling, send a message to a parent or guardian, etc.

In one embodiment, VSS 115 provides educational content to the user via LMS 185 and provides functions to support the educational experience or the instructional capabilities via SMS 165 and/or PSP 195 functionality. In one embodiment, an online discussion interface enables online communication among two or more participants (e.g., user 105). For instance, a participant in a discussion may be an instructor, a student, a parent, an administrator or a course content contributor. In one embodiment, the online discussion interface resembles a group chat interface whereby each participant can view the input of the other participants. In an embodiment, participants may provide input in the form of text, audio (e.g., voice communication), graphics, video, or files (e.g., pdf file). The leader of the discussion, such as an instructor, may be enabled to send private messages during the class discussion that are targeted at a subset of the participants and not generally accessible by the discussion group as a whole. In one embodiment, the online discussion interface provides grading capability that enables an instructor to assign a score to a participant's performance during an online discussion as a whole or to assign a score to individual entries (e.g., distinct items of data input by a participant). The ability to provide separate scores or grades at the individual entry level is a useful instructional feedback mechanism that enables individual learning and helps to improve the quality of subsequent online discussions.

In addition to integrated grading mechanisms, SMS 165 also enables audit functions. An audit module may be configured to enable an auditor to monitor, track, analyze and report on activities and functions within VSS 115 such as instructor activity. In one embodiment the audit module allows a user 105 to set up predefined rules, events and thresholds and to track individual actions and store data on CDR 150. For instance, a regulatory requirement may mandate that an instructor participate in a school discussion by providing feedback and/or comment at a certain level or frequency (e.g., for every 5 entries made by students, instructor must provide an entry). The audit functionality provided by SMS 165 captures this information automatically and provides a mechanism for the auditor to view portal activity, such as an ongoing class discussion, without detection from other users.

In one embodiment, audit functionality is configured to track student attendance. Often, online education providers are required to provide statistics indicating the level of student effort or participation in the educational services. The audit module enables SMS 165 to track and store student activity associated with a course, a plurality of courses, an academic program, or a degree program and format audit reports for compliance with government rules. In one embodiment, the audit module and/or an attendance sub-module detects and stores the number of times the student logs into the course, time spent viewing course content, course content downloads, participation in course discussion groups, completion of assignments and/or interaction with a course instructor.

Coordinating the educational and administrative activities of a school is complex and requires effective communication. VSS 115 includes an automated alert module configured to send automated alerts and/or messages. In one embodiment, administrators use the automated alert module to format messages and deliver them to a targeted set of recipients. In one embodiment, students and parents access messages and send messages by accessing the functions of the automated alert module via PSP 195. Automated alerts may be system messages delivered to a user via a VSS 115 UI, email messages, text messages, short message service (SMS) messages or automated phone messages. Furthermore, automated alerts may be manually entered by a user or may be automatically generated by VSWE 147. In one embodiment the automated alert module is configured to distribute messages to a targeted subset of users including a single user, a user role (e.g. all instructors), a class, a degree program, an academic department, an administrative department, a school, or all users associated with a standardized test.

SMS 165 also enables performance tracking functions. In addition to the previously described online discussion grading functions, in one embodiment VSS 115, via SMS 165, CDR 150 and PSP 195, provides a comprehensive, customizable and flexible performance tracking and reporting mechanism. The performance tracking module of SMS 165 automatically determines the performance tracking and reporting requirements for a student based upon a multitude of factors including predefined rules associated with federal requirements, state requirements, degree requirements, school requirements, the student's past performance, the student's current classes, etc. The performance module accesses CDR 150 data to assess student performance indicators such as the grade in a class, overall grade point average, grade point average in a particular academic discipline, standardized testing scores, grade trends, attendance indicators, attendance trends, etc. In one embodiment, the module determines when a performance report is required based upon a timeframe, the student performance indicators, performance tracking requirements, a student preference, a parent preference, or a guidance counselor preference. When a performance report is required, the module may generate and format a performance report and distribute it to a student, parent, guidance counselor, third-party system, the state government or the federal government. Furthermore, the performance tracking mechanism provides data and calculations to PSP 195 to present in the portal's progress tracking interface.

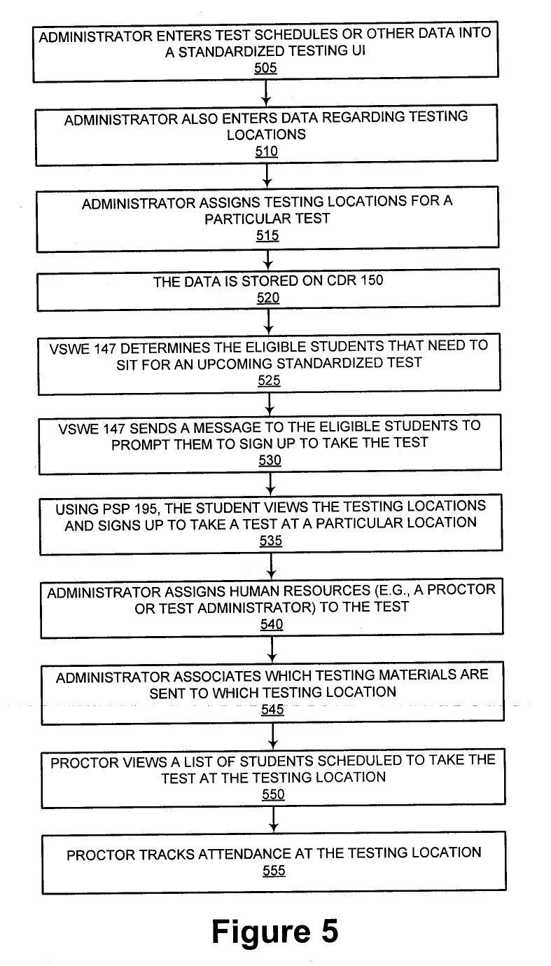

In one embodiment, SMS 165 provides the ability to coordinate the logistics for a standardized testing effort. For example, although the majority of the educational needs for a given program or school is provided directly by VSS 115, some authorities (e.g. a state government) may require students to take a standardized test at a physical location. These tests may be the tests provided by the online educational system provider or they may be provided by a government or other similar authority. One example of such a test is one that a student must pass to graduate high school such as the Arizona Instrument to Measure Standards test or “AIMS” test. SMS 165 provides the ability to coordinate scheduling for these tests. With reference now to FIG. 5, the flow chart depicts a representative embodiment of a process for coordinating a standardized test using VSS 115. Coordination may include entering test schedules or other data into a standardized testing UI (Step 505). In one embodiment, test schedules and other data is imported from an external data source 161 such as a database maintained by a school system. User 105 (e.g. a testing administrator) may also enter data regarding testing locations such as the address, the type of location, special requirements for the location (e.g. parking instructions), and the capacity of the location (Step 510). The testing administrator uses the standardized testing UI of SMS 165 to assign testing locations for a particular test (Step 515). The data is stored on CDR 150 (Step 520).

VSWE 147 accesses student data, standardized testing data and predefined rules on CDR 150 to determine the eligible students that need to sit for an upcoming standardized test (Step 525). VSWE 147 sends a message to the eligible students to prompt them to sign up to take the test (Step 530). For example, the student may receive an email, a letter and/or a message on PSP 195. In one embodiment, VSWE 147 generates a task for a guidance staff member assigned to the student to follow up with the student. Using PSP 195, the student views the testing locations and signs up to take a test at a particular location (Step 535). In one embodiment, signing up for a test may include entering payment information. The testing administrator assigns human resources (e.g. a proctor or test administrator) to the test (Step 540). In one embodiment, the standardized test materials are assigned a unique tracking number so that the testing authority (e.g., the state) can maintain strict accountability for the testing materials. User 105 uses the standardized testing interface to associate which testing materials are sent to which testing location (Step 545). On test day, the testing administrator views (via the UI or via generating a report that is printed) the students that are scheduled to take the test at the testing location (Step 550). The testing administrator uses the standardized testing UI to track attendance at the testing location (Step 555).

In one embodiment, SMS 165 also provides staff members with other information such as employee handbooks, policies, and other beneficial information to staff members. SMS 165 is further configured to provide any number or type of student records and enable staff members to change user identification numbers and passwords as well as make other modifications as necessary.

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed.

The scope of the invention should be determined by the appended claims and their legal equivalents, rather than by the examples given above. Reference to an element in the singular is not intended to mean “one and only one” unless explicitly so stated, but rather “one or more.” Moreover, when a phrase similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. A virtual school system (VSS) comprising:
a student management system (SMS) configured to manage a plurality of students;
a learning management system (LMS) configured to manage and deliver the content of a plurality of online courses;
a school administration system (SAS) configured to manage the administrative functions of at least one virtual school;
a virtual school workflow engine (VSWE) configured to enable definition of predefined rules, evaluate the predefined rules and to automate virtual school processes;
a portal for presenting a plurality of user interfaces (UIs) to a user; and
a central data repository.

2. The VSS of claim 1, further comprising a school set-up module for configuring a plurality of virtual schools, wherein the school set-up module is configured to execute a plurality of school configuration processes.

3. The VSS of claim 2, wherein the school set-up module enables the user to set-up a virtual school based upon at least one of default attribute values or the attributes of an existing school.

4. The VSS of claim 2, wherein the school set-up module comprises a dynamic, interactive, user input process for specifying the attributes of a virtual school.

5. The VSS of claim 1, wherein a virtual school is associated with at least one of an existing physical school or an existing school system, and wherein the school creation process further comprises an automated data upload process configured to import data from at least one external data source.

6. The VSS of claim 2, wherein the VSWE executes a rules definition process comprising:
receiving data for a new rule;
associating the new rule with at least one of a school policy, a virtual school or a virtual school system comprising a plurality of virtual schools; and
storing the new rule in the central data repository as a predefined rule.

7. The VSS of claim 6, wherein the rules definition process further comprises:
querying the central data repository for a list of predefined rules;
identifying an applicable predefined rule from the list of predefined rules;
configuring the parameters of the applicable predefined rule; and
associating the applicable predefined rule with at least one of a virtual school or a virtual school system.

8. The VSS of claim 7, wherein the rules definition process further comprises automatically updating the predefined rules, by accessing data from at least one of the central data repository, an external system, a web site, a database and a third-party data service.

9. The VSS of claim 1, wherein the predefined rules comprise rules determined by at least one of: an accreditation authority, a school board, a school district, a state government, the federal government, an education industry standard, online privacy best practices, date, time, student location, student type, class type, course subject matter, degree type, sex of student, age of student, race of student, or economic classification of student.

10. The VSS of claim 1, wherein the VSWE is further configured to automate, track, route, status and manage tasks, messages and events associated with the SMS, the LMS, the SAS, and the integrated virtual school processes.

11. The VSS of claim 1, wherein the central data repository comprises data associated with a plurality of virtual schools, a plurality of instructors, a plurality of students, student performance records, student attendance records, and the predefined rules.

12. The VSS of claim 1, wherein the plurality of UIs are at least one of configurable, customizable, data driven and dynamic.

13. The VSS of claim 1, wherein the portal is a web portal comprised at least partially of web parts.

14. The VSS of claim 1, wherein the portal comprises an online discussion UI that enables online communication between a plurality of participants, wherein each participant in the plurality of participants comprises at least one of an instructor, a student, a parent, an administrator or a course content contributor.

15. The VSS of claim 14, further comprising a discussion grading module configured to interface with the online discussion UI and to enable an instructor to assign a score to each entry in a class discussion, wherein the class discussion comprises a plurality of entries entered by the plurality of participants.

16. The VSS of claim 15, further comprising an audit module configured to enable an auditor to at least one of monitor, track, analyze or report on instructor activity.

17. The VSS of claim 1, further comprising an audit module configured to track portal activity and store a record of user activity on the central data repository.

18. The VSS of claim 17, wherein the audit module is further configured to track student activity associated with at least one of a course, a plurality of courses, an academic program, or a degree program and format audit reports.

19. The VSS of claim 1, further comprising an automated alert module configured to send automated alerts, wherein automated alerts comprise at least one of system messages, email messages, text messages, short message service messages or automated phone messages, and wherein the automated alerts are at least one of entered by a user or automatically generated in response to an instruction from the VSWE.

20. The VSS of claim 19, wherein the automated alert module is configured to distribute messages to at least one of a single user or a subset of users wherein the subset is determined by a user role, a class, a degree program, an academic department, an administrative department, a school, an assessment, or a test.

21. The VSS of claim 1, wherein the SMS is configured to automate a plurality of student management functions and wherein the SMS comprises at least one of an admissions module, a student registration module, a course registration module, a course planning module, a student counseling module, a course scheduling module, a performance tracking module, an attendance tracking module, or an assessment reporting module.

22. The VSS of claim 21, wherein attendance tracking comprises tracking the date, time and duration that a student participates in a particular course.

23. The VSS of claim 21, wherein the admissions module is configured to execute an admissions process comprising:
receiving an application request;
configuring an application form, wherein the application form is a UI whose content is determined at least partially by the application request;
receiving application data, wherein at least a portion of the application data is entered in the application form by the user;
storing the application data in the central data repository;
sending an automated message to at least one of an admissions specialist, a guidance counselor or a school administrator;
receiving at least one admissions response associated with the automated message;
determining an admissions decision based at least partially upon the admissions response; and
informing the user of the admissions decision.

24. The VSS of claim 21, wherein the student registration module is configured to execute a student registration process comprising:
receiving a student registration request to register a student for at least one of a school, a degree program, a class, an academic period, a semester, a trimester or a quarter configuring an application form, wherein the application form is a student management UI whose content is determined at least partially by the student registration request;
determining if the student is an admitted student;
receiving student registration information; and
sending a registration status.

25. The VSS of claim 21, wherein the student registration process further comprises receiving payment information associated with the student registration request.

26. The VSS of claim 21, wherein the course registration module is configured to execute a course registration process comprising:
presenting the user with course information for a plurality of courses, wherein the course information is determined at least partially by data received from the LMS, and wherein the course information comprises at least one of course description, credit information, satisfaction of degree requirements, and course cost;
receiving input selecting a course for registration of a student;
evaluating predefined rules associated with at least one of the student, the course, and the degree program associated with the student to determine a course approved indicator;
determining if guidance counselor approval is required for the course, wherein the determining is based at least partially on the student counseling process;
when guidance counselor approval is required, sending an automated message to a guidance counselor to determine a guidance counselor approval indicator; and
notifying the student of the course registration status, wherein the status is based at least partially on the course approved indicator and the guidance counselor approval indicator.

27. The VSS of claim 21, wherein the course planning module is configured to execute a course planning process comprising:
determining a list of recommended courses for a student based upon at least one of the predefined rules, a request from the student, a parent request, a teacher recommendation, and a guidance counselor recommendation;
determining a recommended course plan for one or more course delivery periods based upon the list of recommended courses;
presenting the recommended course plan to the user;
receiving input of a first course plan from at least one of the student, the teacher, the guidance counselor, the administrator and the parent; and
providing feedback on the first course plan based at least partially on the predefined rules.

28. The VSS of claim 21, wherein the course planning process further comprises:
receiving a second course plan from at least one of the student, the teacher, the guidance counselor, the administrator and the parent; and
storing at least one of the first course plan and the second course plan in the central data repository.

29. The VSS of claim 21, wherein the course planning process further comprises facilitating online communication between at least two of the student, a teacher, a guidance counselor, an administrator and a parent.

30. The VSS of claim 21, wherein the student counseling module is configured to execute a student counseling process comprising:
assigning the student to a guidance counselor;
querying the central data repository determine a student for counseling, wherein the querying is based upon predefined rules; and
facilitating the scheduling of a counseling conference between the guidance counselor and at least one of the student, a parent of the student, and a teacher of the student.

31. The VSS of claim 30, wherein the student counseling process further comprises sending an automated alert based upon the assignment of the student to the guidance counselor.

32. The VSS of claim 21, wherein the performance tracking module is configured to execute a performance tracking process comprising:
determining the performance tracking requirements for a student based upon predefined rules associated with at least one of federal requirements, state requirements, degree requirements, school requirements, student's past performance, and student's current classes; and
storing an association of the performance tracking rules and the student.

33. The VSS of claim 32, wherein the performance tracking process further comprises:
retrieving student performance indicators associated with the student's current classes;
determining when a performance report is required based at least partially upon date, time, the student performance indicators, the performance tracking requirements, a student preference, a parent preference, and a guidance counselor preference; and
when a performance report is required, formatting a performance report and distributing it to at least one of the student, the parent, the guidance counselor, a third-party system, the state government and the federal government.

34. The VSS of claim 21, wherein the attendance tracking module is configured to execute an attendance tracking process comprising tracking the student participation in a course based upon at least one of: the number of times the student logs into the course, time spent viewing course content, course content downloads, participation in course discussion groups, completion of assignments and interaction with a course instructor.

35. The VSS of claim 1, further comprising a security module configured for at least one of: role-based security, data encryption, user activity tracking, user location tracking, or restricting access to data based upon predefined rules associated with at least one of privacy law or privacy policy.

36. The VSS of claim 1, further comprising an admissions UI comprising at least one of student profile data, an admissions checklist, links to documents associated with a student, links to resources and forms, or degree enrollment data.

37. The VSS of claim 1, further comprising a course information UI comprising at least one of test results, instructor information, a progress indicator, attendance data, or a messaging interface.

38. The VSS of claim 1, further comprising a guidance UI comprising at least one of a graduation progress indicator, transcript data, an academic status indicator, or standardized testing data.

39. The VSS of claim 1, further comprising a social networking UI comprising at least one of student yearbook information, newsletters, literature magazines, blogs, or peer-to-peer communication functions.

40. The VSS of claim 1, further comprising a knowledge center UI comprising a course catalog, FAQs, a student handbook, course expectations, tutorials, or student orientation data.

41. The VSS of claim 1, further comprising a student portfolio UI comprising at least one of accomplishment data, post graduation plans, academic work samples, unofficial transcript information, or course syllabi.

42. The VSS of claim 1, wherein the portal is configured to present course content stored in a learning management system (LMS).

43. The VSS of claim 1, wherein the LMS is configured to automate a plurality of learning management functions comprising at least one of course development, course management, course delivery, assessment creation, assessment delivery, or assessment evaluation.

44. The VSS of claim 11, wherein course management comprises enforcing course content requirements, mandated by at least one of an accreditation authority, a school board, a school district, a state government, the federal government, or an education industry standard.

45. The VSS of claim 11, wherein test delivery comprises facility coordination between a student and a third-party testing entity for taking a test at a physical testing facility, wherein the third-party testing entity is at least one of a school system, a school, or a government organization.

46. The VSS of claim 11, wherein course management comprises approving a course for course delivery, assigning an instructor to the course and allowing students to enroll in the course.

47. The VSS of claim 1, wherein the LMS is a third-party commercial software system hosted by the VSS.

48. The VSS of claim 1, wherein the SAS is configured to automate a plurality of school administrative functions and comprises at least one of a budgeting module, a finance module, a resource management module, an operational performance tracking and reporting module, a regulatory module or a compliance reporting module.

49. The VSS of claim 48, wherein the operational performance tracking and reporting module is configured to execute a operational performance process comprising:
defining a performance goal for a virtual school, wherein the performance goal is associated with at least one of a school policy, a state requirement, a federal requirement, or a predefined rule;
storing performance indicators, wherein performance indicators are associated with at least one of student test results, student attendance, instructor evaluations, number of students enrolled, student progress, student degree attainment, number of courses offered, type of courses offered, or number of counseling sessions delivered; and
determining if the performance goal is met, wherein the determining is automatically triggered by at least one of an event, a request, a date or a time duration.

50. The VSS of claim 1, wherein the VSS is delivered to the user via at least one of a hosted service, a web service, or a plurality of web services.

51. The system of claim 1, wherein the users are assigned to roles that are used to determine at least one of user permissions or default user interfaces.

52. A computer interface to a virtual school comprising:
a virtual class room;
a messaging user interface (UI);
an admissions UI;
a course information UI;
a guidance UI; and
a module configured to communicate with a central data repository associated with the virtual school.

53. The computer interface of claim 52, further comprising at least one of a social networking UI, a knowledge center UI, or a student portfolio UI.

54. A system, comprising:
a memory for storing a computer program for grading participation in an online discussion; and a processor coupled to said memory for executing said computer program, wherein said computer program is configured to perform a method comprising:
displaying a plurality of discussion entries on a computer interface, wherein the discussion items are entered by a plurality of participants of an online discussion;
receiving a selection by a grader using the computer interface of a first discussion entry in the plurality of discussion entries;
displaying a first grading input form on the computer interface enabling a the grader to enter grading data;
receiving the first grading data from the grading input form;
associating the first grading data with the first discussion entry.

55. A system, comprising:
a memory for storing a computer program for course planning; and a processor coupled to said memory for executing said computer program, wherein said computer program is configured to perform a method comprising:
determining a list of recommended courses for a student based upon at least one of predefined rules, a request from the student, a parent request, a teacher recommendation, and a guidance counselor recommendation;
automatically determining a recommended course plan for the student for one or more course delivery periods;
sending an automated message presenting the recommended course plan to a user;
receiving an approval from the user;
registering the student for at least a portion of the courses in the recommended course plan.

56. A system, comprising:
a memory for storing a computer program for auditing users of a virtual school system (VSS); and a processor coupled to said memory for executing said computer program, wherein said computer program is configured to perform a method comprising:
receiving a selection of a target user, wherein the target user comprises at least one of an administrator, an instructor, a parent and a student;
tracking target user activity, wherein user activity comprises at least one of logging into the VSS, logging out of the VSS, accessing course content, participating in an online discussion, clicking in response to a prompt, entering data, or accessing VSS administrative functions.
